(19) United States
(12) Patent Application Publication
(10) Pub. No.: US 2022/0318607 A1
(43) Pub. Date: Oct. 6, 2022

(54) PROCESSOR, DATA PROCESSING METHOD AND ELECTRONIC DEVICE

(71) Applicant: Lenovo (Beijing) Limited, Beijing (CN)

(72) Inventors: Xueli BAN, Beijing (CN); Qihua XIAO, Beijing (CN); Danyu WANG, Beijing (CN); Zhijian MO, Beijing (CN)

(21) Appl. No.: 17/548,956

(22) Filed: Dec. 13, 2021

(30) Foreign Application Priority Data
Mar. 30, 2021 (CN) 202110340999.4

(51) Int. Cl. G06N 3/063; G06F 3/16

(52) U.S. Cl. CPC G06N 3/063; G06F 3/162

(57) ABSTRACT

A processor includes a first processing unit, a second processing unit, a third processing unit, a system control unit, and a storage unit. The first processing unit is configured to obtain data transmitted to the processor and determine whether the data is to be processed by the first processing unit, the second processing unit, or the third processing unit. The second processing unit is configured to execute a neural network algorithm. The third processing unit is configured to perform a feature extraction algorithm on the data. The system control unit is configured to control power supply information of each of the first processing unit, the second processing unit, and the third processing unit. The storage unit is configured to store at least data processing algorithms performed by the first processing unit, the second processing unit, and the third processing unit.

### CROSS-REFERENCE TO RELATED APPLICATION

This application claims priority to Chinese Application No. 202110340999.4, filed on Mar. 30, 2021, the entire contents of which are incorporated herein by reference.

### FIELD OF THE DISCLOSURE

The present disclosure generally relates to the field of control technology and, more particularly, to a processor, a data processing method and an electronic device.

### BACKGROUND

A central processing unit (CPU) and a graphics processing unit (GPU) are used as comprehensive computing units in an electronic device and need to execute multiple processes or events at the same time, thereby causing excessive loads on the CPU or GPU and a high system power consumption, which is detrimental to an efficient operation of the system.

### SUMMARY

In accordance with the disclosure, there is provided a processor including a first processing unit, a second processing unit, a third processing unit, a system control unit, and a storage unit. The first processing unit is configured to obtain data transmitted to the processor and determine whether the data is to be processed by the first processing unit, the second processing unit, or the third processing unit. The second processing unit is configured to execute a neural network algorithm. The third processing unit is configured to perform a feature extraction algorithm on the data. The system control unit is configured to control power supply information of each of the first processing unit, the second processing unit, and the third processing unit. The storage unit is configured to store at least data processing algorithms performed by the first processing unit, the second processing unit, and the third processing unit.

Also in accordance with the disclosure, there is provided a data processing method including obtaining data transmitted to a first processing unit and analyzing the data to determine whether the data is to be processed by the first processing unit, a second processing unit, or a third processing unit. The second processing unit is configured to execute a neural network algorithm. The third processing unit is configured to perform feature extraction on the data. Data processing algorithms performed by the first processing unit, the second processing unit, and the third processing unit are stored in a same storage unit.

Also in accordance with the disclosure, there is provided an electronic device including a sensor, a processor, and a central processing unit (CPU). The sensor is configured to detect data and send the data to the processor. The processor includes a first processing unit, a second processing unit, a third processing unit, a system control unit, and a storage unit. The first processing unit is configured to obtain the data and determine whether the data is to be processed by the first processing unit, the second processing unit, or the third processing unit. The second processing unit is configured to execute a neural network algorithm. The third processing unit is configured to perform a feature extraction algorithm on the data. The system control unit is configured to control power supply information of each of the first processing unit, the second processing unit, and the third processing unit. The storage unit is configured to store at least data processing algorithms performed by the first processing unit, the second processing unit, and the third processing unit. The CPU is configured to obtain a processing result output by the processor.

### BRIEF DESCRIPTION OF THE DRAWINGS

In order to provide a clearer illustration of various embodiments of the present disclosure, the drawings used in the description of the disclosed embodiments are briefly described below. It is apparent that the following drawings are merely example embodiments of the present disclosure. Other drawings may be obtained based on the disclosed drawings by those skilled in the art without creative efforts.

FIG. 1 is a schematic structural diagram of a processor according to an embodiment of the disclosure.

FIG. 2 is a schematic diagram showing data processing by a processor according to an embodiment of the disclosure.

FIG. 3 is a schematic structural diagram of another processor according to an embodiment of the disclosure.

FIG. 4 is a schematic diagram showing sound processing according to an embodiment of the disclosure.

FIG. 5 is a schematic diagram showing realization of multiplexing a connection channel of a positive and negative plug interface according to an embodiment of the disclosure.

FIG. 6 is a schematic diagram showing controlling an external display via a processor according to an embodiment of the disclosure.

FIG. 7 is a flowchart of a data processing method according to an embodiment of the disclosure.

FIG. 8 is a schematic structural diagram of an electronic device according to an embodiment of the disclosure.

### DETAILED DESCRIPTION OF THE EMBODIMENTS

In order to provide a clear illustration of the present disclosure, embodiments of the present disclosure are described with reference to the drawings. It is apparent that the described embodiments are merely some of embodiments of the present disclosure, but not all of embodiments of the present disclosure. Other embodiments obtained based on the disclosed embodiments by those skilled in the art without creative efforts are intended to be within the scope of the present disclosure.

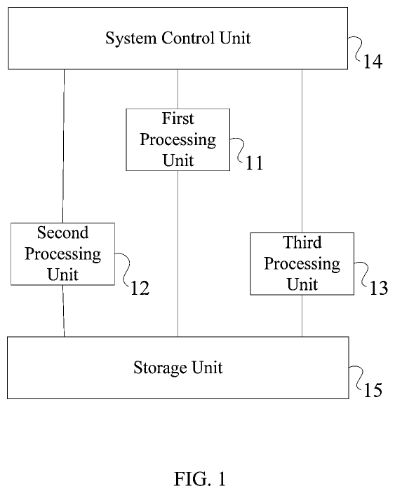

FIG. 1 is a schematic structural diagram of a processor consistent with the disclosure. As shown in FIG. 1, the processor includes at least three processing units. The at least three processing units include a first processing unit 11, a second processing unit 12, and a third processing unit 13. The processor further includes a system control unit 14 and a storage unit 15.

The first processing unit 11 can obtain data transmitted to the processor, and determine whether the data is to be processed by the first processing unit 11, the second processing unit 12 or the third processing unit 13.

The second processing unit 12 can be configured to execute neural network algorithms.

The third processing unit 13 can be configured to perform a feature extraction algorithm on the data.

The system control unit 14 can be configured to control power supply information of each of the at least three processing units.

The storage unit 15 can be configured to store at least data processing algorithms performed by the first processing unit 11, the second processing unit 12, and the third processing unit 13.

The processor consistent with the disclosure can include at least three processing units, and each processing unit can process different data, such that the multiple processing units can process multiple data at the same time, thereby improving a data processing efficiency. The processor consistent with the disclosure, including the at least three processing units, the system control unit, and the storage unit, is different from the CPU or GPU. The processor can process the obtained data, thereby sharing an amount of data computation performed by the CPU or GPU, reducing a power consumption of the CPU or GPU, and improving an operating efficiency of a system including the processor and the CPU.

The data processing algorithms needed by the first processing unit 11, the second processing unit 12, and the third processing unit 13 can be stored in the same storage unit 15. When the first processing unit 11, the second processing unit 12, or the third processing unit 13 needs to process the data, the corresponding processing algorithm can be directly called from the storage unit 15, such that the corresponding processing unit can execute the called algorithm to process the data.

For example, when the processor obtains first data, the first processing unit 11 can determine that the first data is to be processed by the second processing unit 12, and hence, the second processing unit 12 can obtain the first data, and call the algorithm needed by executing the neural network from the storage unit 15. After calling the algorithm, the second processing unit 12 can execute the algorithm to realize the processing of the first data.

The storage unit 15 can include a dynamic random access memory (DRAM).

The system control unit 14 can control the power supply information of each of the at least three processing units. For example, it can control whether to supply power to a certain processing unit or multiple processing units, or whether to power off a certain processing unit or multiple processing units, or whether to power on or power off certain one or multiple devices of the processor.

The system control unit 14 can be configured to not only control the power supply information of at least three processing units, but also control the power supply information of each device of the processor. In some embodiments, the system control unit 14 can be further configured to control a system timing to ensure a normal operation of the processor.

The system control unit 14 can include a microcontroller unit (MCU), or an embedded controller (EC).

The second processing unit 12 can be configured to execute the neural network algorithms and process neural network data, and the second processing unit 12 can include a neural network engine (NN Engine). The third processing unit 13 can be configured to perform the feature extraction algorithm on the data to, e.g., extract audio features and the like, and the third processing unit 13 can include a digital signal processor (DSP) engine.

The first processing unit 11 can be configured to obtain the data transmitted to the processor, analyze the data, determine a type of the data, and thus, determine which processing unit can process the data.

In some embodiments, the data transmitted to the processor may be first stored in the storage unit 15, and then the data can be called by the first processing unit 11 from the storage unit 15. In some embodiments, the data transmitted to the processor can be directly transmitted to the first processing unit 11 of the processor, such that the first processing unit 11 can directly analyze and process the data.

The first processing unit 11 can analyze the data to obtain the type of the data, and allocate the corresponding processing unit for data processing according to the type of the data. For example, if the obtained data is audio data, the first processing unit 11 can send the audio data to the third processing unit 13 for data processing, and if the obtained data is distance-related, e.g., a data total distance flow (TDF), the first processing unit 11 can send the data to the second processing unit 12 for data processing.

The data to be processed by the first processing unit 11 can include data other than the data that can be processed by the second processing unit 12 and the third processing unit 13. That is, all of the data that cannot be processed by the second processing unit 12 and the third processing unit 13 can be processed by the first processing unit 11.

The first processing unit 11 can first determine the type of data that can be processed by each processing unit, and thus, after obtaining the data transmitted to the processor, can allocate a corresponding processor based on the type of the obtained data.

When determining that the obtained data can be processed by the second processing unit 12 or the third processing unit 13, the first processing unit 11 can send the obtained data to the second processing unit 12 or the third processing unit 13. The second processing unit 12 or the third processing unit 13 can call the data processing algorithm from the storage unit 15, and the second processing unit 12 or the third processing unit 13 can execute the called algorithm to process the obtained data.

After processing the obtained data, the second processing unit 12 or the third processing unit 13 can obtain a processing result and return the processing result to the first processing unit 11. The first processing unit 11 can store the processing result in the storage unit 15, such that when the processing result needs to be called, it can be directly called from the storage unit 15.

After processing the obtained data, the second processing unit 12 or the third processing unit 13 can obtain the processing result and directly send the processing result to the storage unit 15 for storage and the first processing unit 11 at the same time, such that the first processing unit 11 can determine whether further processing is needed on the processing result.

For example, the data transmitted to the processor is the audio data. The first processing unit 11 can analyze the audio data, determine that the data processing can be performed by the third processing unit 13, and send the audio data to the third processing unit 13. After obtaining the audio data, the third processing unit 13 can call the feature extraction algorithm from the storage unit 15, and execute the feature extraction algorithm on the audio data to obtain the processing result. The third processing unit 13 can send the processing result to the first processing unit 11, and the first processing unit 11 can obtain the processing result after feature extraction of the audio data, and send the processing result to the second processing unit 12. The second processing unit 12 can call and execute the corresponding algorithm, thereby realizing a feature authentication of the audio features, such that the second processing unit 12 can send an authentication result to the first processing unit 11 after obtaining the authentication result.

If the first processing unit 11 determines that the obtained data needs to be processed by the first processing unit 11, the first processing unit 11 can directly call the corresponding algorithm from the storage unit 15 and execute the algorithm to process the data and obtain the processing result.

If the first processing unit 11 processes the data to obtain the processing result, the first processing unit 11 can send the processing result to the storage unit 15 for storage. The first processing unit 11 can determine whether the processing result needs to be further processed, and if necessary, determine whether the further processing is performed by the first processing unit 11, the second processing unit 12, or the third processing unit 13.

The first processing unit 11 can include a reduced instruction set computer five (RISC-V) processing unit.

In some embodiments, the processor can further include another processing unit, for example, an independent security encryption processing unit (e.g., a crypto engine) configured for data encryption and decryption protection, e.g., storing passwords and other related data, and processing encryption and decryption.

The processor consistent with the disclosure can include at least three processing units, e.g., the first processing unit 11, the second processing unit 12, and the third processing unit 13. The first processing unit 11 can obtain the data transmitted to the processor, and determine whether the data is to be processed by the first processing unit 11, the second processing unit 12, or the third processing unit 13. The second processing unit 12 can be configured to process the data using the neural network, and the third processing unit 13 can be configured to perform feature extraction on the data. The processor consistent with the disclosure can further include the system control unit 14 configured to control the power supply information of each of the at least three processing units, and the storage unit 15 configured to store at least the data processing algorithms needed by the first processing unit 11, the second processing unit 12, and the third processing unit 13. In some embodiments, the data can be obtained and processed by the first processing unit 11, the second processing unit 12, or the third processing unit 13, such that the data can be processed by the processor other than the CPU. The first processing unit 11, the second processing unit 12 and the third processing unit 13 can be configured to process different data, and thus, different types of data can be processed in the processor at the same time, thereby improving a data processing speed of the processor. The problems of heavy load and high-power consumption caused by all data being processed in the same processor or processing unit can be avoided, the power consumption requirements of the CPU can be reduced, and an operating efficiency of the system can be improved.

In some embodiments, as shown in FIG. 1, the processor includes at least three processing units. The at least three processing units includes the first processing unit 11, the second processing unit 12, and the third processing unit 13. The processor further includes the system control unit 14 and the storage unit 15.

The storage unit 15 can be further configured to store data detected by at least one sensor.

The first processing unit 11 obtaining the data transmitted to the processor can include the first processing unit 11 obtaining the data detected by at least one sensor and stored in the storage unit 15.

When the at least one sensor sends the detected data to the storage unit 15 of the processor for storage, each sensor in the at least one sensor can first send the detected data to a control unit corresponding to the sensor of the processor. Each sensor can have a corresponding control unit configured to obtain the data of the sensor and perform preliminary processing on the data detected by the sensor. The preliminary processing can include processing the data detected by the sensor into data recognized by the processing unit of the processor, and then store the recognized data in the storage unit 15.

If the storage unit 15 stores the data detected by the at least one sensor, the at least three processing units can process the data detected by the at least one sensor. That is, the processor consistent with the disclosure can process the data detected by the at least one sensor. Therefore, the CPU or GPU of the system including the storage unit 15 does not need to process the data detected by the sensor, which reduces the amount of calculations by the CPU or GPU. Through an independent processor to process the data detected by the sensor, the efficiency of data processing can be improved. The independent processor including at least three processing units configured to process different types of data detected by the sensor, thereby ensuring the high efficiency of data processing.

The first processing unit 11 can store the processing result obtained by the first processing unit 11, the second processing unit 12, or the third processing unit 13 to the storage unit 15, and send the notification message that the processing result is stored in the storage unit 15 to the CPU. The storage unit 15 can be further configured to send the stored processing result to the CPU according to a call command of the CPU.

In some embodiments, when the first processing unit 11, the second processing unit 12, or the third processing unit 13 processes the obtained data and obtains the processing result, the processing result can be directly stored from the first processing unit 11 to the storage unit 15, or the obtained processing result can be sent to the first processing unit 11 and stored in the storage unit 15 by the second processing unit 12 or the third processing unit 13 at the same time. In some other embodiments, after the processing result is obtained, the first processing unit 11 can first determine whether the processing result needs to be further processed, and if not, the processing result can be directly sent to the storage unit 15 for storage. If necessary, the first processing unit 11 can analyze the processing result to determine which processing unit will perform further processing on the processing result, until the first processing unit 11 determines that a final processing result can no longer be processed, and store the final processing result in the storage unit 15.

After the first processing unit 11 send the processing result obtained by the first processing unit 11, the second processing unit 12, or the third processing unit 13 to the storage unit 15 for storage, the first processing unit 11 can send the notification message to the CPU to notify that the data transmitted to the processor is processed, the processing result is obtained, and the processing result is stored in the storage unit 15. Therefore, when the CPU needs to obtain the processing result of the data transmitted to the processor, the processing result can be directly called from the storage unit 15.

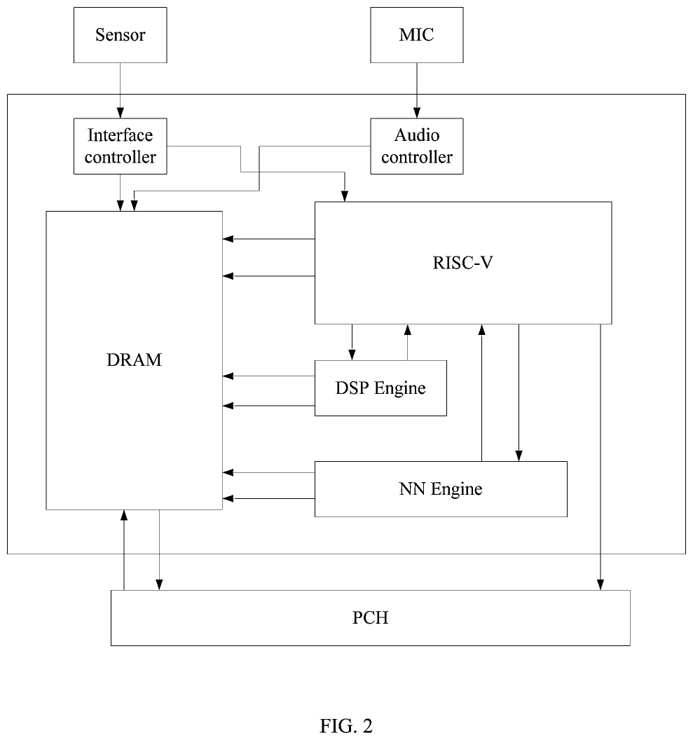

FIG. 2 is a schematic diagram showing the data processing by the processor consistent with the disclosure. As shown in FIG. 2, data is transmitted to the processor by an external sensor and processed by the processor, and the processing result is output to a platform controller hub (PCH) of the CPU. As shown in FIG. 2, a system includes a first processing unit denoted as RISC-V, a second processing unit denoted as NN Engine, a third processing unit denoted as DSP Engine, a storage unit denoted as DRAM, at least one sensor denoted as Sensor, one or more control units corresponding to the at least one sensor denoted as Interface Controller, an audio receiving unit denoted as MIC (Microphone), an audio control unit denoted as Audio Controller, a south bridge denoted as PCH of the CPU. The processor can include the first processing unit denoted as RISC-V, the second processing unit denoted as NN Engine, the third processing unit denoted as DSP Engine, the storage unit denoted as DRAM, the at least one sensor denoted as Sensor, the one or more control units corresponding to the at least one sensor denoted as Interface controller, the audio receiving unit denoted as MIC, and the audio control unit denoted as Audio Controller.

The audio receiving unit (MIC) or the sensor (Sensor) can detect the data, and directly send the data to the control unit corresponding to the sensor of the processor. The control unit can recognize the data obtained by the sensor, and then write the data to the storage unit (DRAM) for storage. The control unit can notify the first processing unit (RISC-V) that the data is stored in the storage unit.

After the first processing unit (RISC-V) obtains the notification message from the control unit, the first processing unit (RISC-V) can call the stored data from the storage unit (DRAM), and then analyze the data and determine whether it is to be processed by the first processing unit (RISC-V), the second processing unit (NN Engine), or the third processing unit (DSP Engine).

If the data in the storage unit (DRAM) is stored by the audio receiving unit (MIC), the first processing unit (RISC-V) can send the data to the third processing unit (DSP Engine). The third processing unit (DSP Engine) can perform the feature extraction on the audio data, and then send the processing result including extracted features to the storage unit (DRAM) and the first processing unit (RISC-V) at the same time. The first processing unit (RISC-V) can determine whether to the processing result need to be further processed. If no further processing is needed, the first processing unit (RISC-V) can send the notification message to the south bridge (also referred to as “Platform Controller Hub (PCH)”) of the CPU to notify the PCH that the current data is processed and the processing result is obtained and stored in the storage unit (DRAM). After the PCH receives the notification message, if the processing result of the audio data needs to be obtained, the PCH can send the call command to the storage unit (DRAM) through a Universal Serial Bus (USB) interface. The storage unit (DRAM) can send the processing result to the CPU according to the call command of the PCH, such that the processing result of the audio data is obtained by the processor and fed back to the CPU.

The first processing unit (RISC-V) can send the notification message to the south bridge (PCH) of the CPU to notify the PCH that the processing result of the data is stored in the storage unit (DRAM). The notification message can carry a storage address of the processing result in the storage unit (DRAM), which is the same as an address when the control unit writes the data detected by the sensor into the storage unit (DRAM). For example, the DRAM can store the data detected by the sensor and the processing result of the data at a same address in the storage unit (DRAM).

If the first processing unit (RISC-V) determines that the data needs to be processed by the second processing unit (NN Engine) or the first processing unit (RISC-V), the data processing procedure are similar to the procedure described above, except that the processing unit and algorithm used for data processing are different, thus detailed description will be omitted herein.

The processor consistent with the disclosure can include at least three processing units, e.g., the first processing unit, the second processing unit, and the third processing unit. The first processing unit can obtain the data transmitted to the processor, and determine whether the data is to be processed by the first processing unit, the second processing unit, or the third processing unit. The second processing unit can be configured to process the data using the neural network, and the third processing unit can be configured to perform feature extraction on the data. The processor consistent with the disclosure can further include the system control unit configured to control the power supply information of each of the at least three processing units, and the storage unit configured to store at least the data processing algorithms needed by the first processing unit, the second processing unit, and the third processing unit. In some embodiments, the data can be obtained by the processor and processed by the first processing unit, the second processing unit, or the third processing unit, such that the data can be processed by the processor other than the CPU. The first processing unit, the second processing unit and the third processing unit can be configured to process different data, and thus, different types of data can be processed in the processor at the same time, thereby improving the data processing speed of the processor. The problems of heavy load and high-power consumption caused by all data being processed in the same processor or processing unit can be avoided, the power consumption requirement of the CPU can be reduced, and the operating efficiency of the system can be improved.

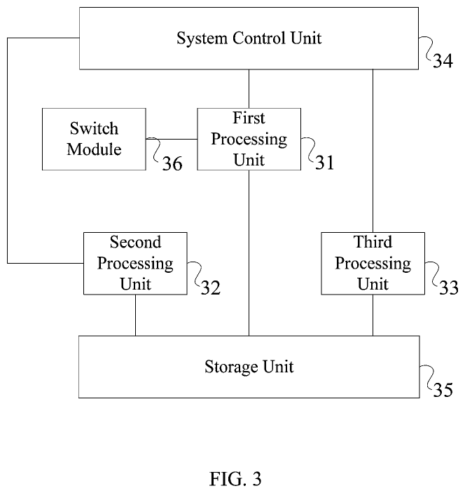

FIG. 3 is a schematic structural diagram of another processor consistent with the disclosure. As shown in FIG. 3, the processor includes at least three processing units. The at least three processing units includes a first processing unit 31, a second processing unit 32, and a third processing unit 33. The processor further includes a system control unit 34, a storage unit 35, and a switch module (switch) 36.

The processor has a structure that is similar to the structures of the processor shown in FIG. 1, except that the processor shown in FIG. 3 further includes the switch module 36.

The switch module 36 can have at least two states.

When the switch module 36 is in a first state, the first processing unit 31 can obtain the audio data, such that the processor can perform an ultrasonic detection on a part of the audio data. The ultrasonic detection can include human body detection, motion track detection, or the like. When the switch module 36 is in a second state, the first processing unit 31 does not obtain the audio data.

A user can determine which state the switch module 36 is in according to the user's needs. When the switch module 36 is in the first state, the processor can perform the ultrasonic detection on the audio data, and when the switch module 36 is in the second state, the processor does not perform the ultrasonic detection on the audio data. The processor does not perform any processing on the audio data, and the Audio Controller of the system can directly perform a normal sound input processing on the audio data.

The switch module 36 can further have a third state. In the third state, the first processing unit 31 can obtain the audio data and perform the ultrasonic detection on a part of the audio data, and the Audio Controller of the system can also perform the normal sound input processing on the audio data. For example, when the switch module 36 is in the third state, the Audio Controller of the system can perform the normal sound input processing on the data, and after the data is analyzed by the Audio Controller of the processor, the first processing unit 31 or the third processing unit 33 can perform the ultrasonic detection on the data.

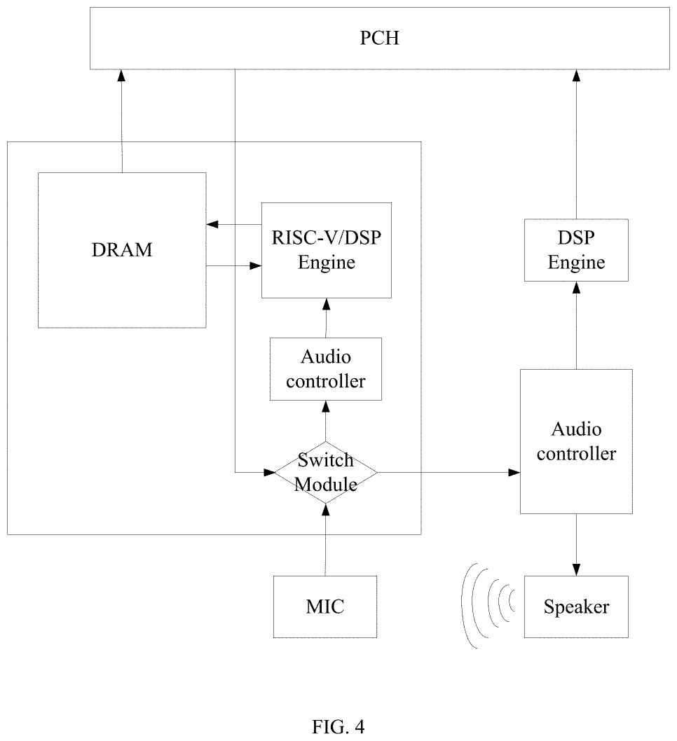

FIG. 4 is a schematic diagram showing the sound processing consistent with the disclosure. As shown in FIG. 4, the system includes the south bridge denoted as PCH, the DSP Engine, the Audio controller, the audio receiving unit denoted as MIC, the switch module, the audio control unit denoted as Audio Controller, the first processing unit denoted as RISC-V, the third processing unit denoted as DSP Engine and the storage unit denoted as DRAM.

If the switch module is controlled to be in the second state according to the user's needs, when detecting the audio data, the audio receiving unit (MIC) can transmit the audio data to the switch module. Since the switch module is in the second state, the switch module can directly send the audio data to the Audio Controller of the system, and the DSP Engine of the system can perform the normal sound input processing on the audio data, and transmit the processing result to the south bridge (PCH).

If the switch module is controlled to be in the first state according to the user's needs, a command instructing the switch module to be in the first state can be sent to the switch module through the PCH. When or after the switch module is adjusted to the first state, the switch module can control the Audio Controller of the system to turn on an ultrasonic playback mode. For example, a speaker of the audio output unit of the system can output ultrasonic audio, such that the MIC can receive the ultrasonic audio.

When the audio receiving unit (MIC) detects the audio data, the audio data can be transmitted to the switch module. Since the switch module is in the first state, the switch module does not send the audio data to the Audio Controller of the system, but directly send the audio data to the audio control unit (Audio Controller) of the processor. After the audio control unit (Audio Controller) of the processor recognizes the data, the data can be transmitted to the first processing unit (RISC-V), and the first processing unit (RISC-V) can determine whether the data is to be processed by the first processing unit or the third processing unit (DSP Engine). No matter the data is to be processed by the first processing unit (RISC-V) or the third processing unit (DSP Engine), the ultrasonic algorithm needs to be called from the storage unit (DRAM) to perform the ultrasonic detection, so as to determine the motion trajectory or human body position, and the like. When the south bridge (PCH) sends the calling command, the ultrasonic detection results, e.g., the gesture trajectory or the human body position, can be transmitted to the south bridge (PCH).

If the switch module is controlled to be in the third state according to the user's needs, a command instructing that the switch module is in the third state can be sent to the switch module through the PCH. When or after the switch module is adjusted to the third state, the switch module can control the Audio controller of the system to turn on the ultrasonic playback mode. The speaker of the audio output unit of the system can output the ultrasonic audio and the ordinary audio data, i.e., non-ultrasonic audio data, at the same time, such that the MIC can receive both the ultrasonic audio and the ordinary audio.

When detecting the audio data, the audio receiving unit (MIC) can transmit the data to the switch module. When the switch module is in the third state, the switch module can send the part of the audio data having frequencies less than or equal to 20 kHz to the audio control unit (Audio Controller) of the system and the DSP Engine of the system can perform the ordinary sound processing on the part of audio data. The switch module can send the part of the audio data having frequencies greater than 20 kHz to the audio control unit (Audio Controller) of the processor, such that the processor can perform the ultrasonic detection on the part having frequencies greater than 20 kHz to determine the motion trajectory or the position of the human body and the like. When the south bridge (PCH) sends the calling command, the ultrasonic detection results, such as the gesture movement trajectory or the human body position, can be transmitted to the south bridge (PCH).

It should be noted that the system consistent with the disclosure can include an electronic device including both the CPU and the processor consistent with embodiment, or a system carrying the electronic device.

The processor consistent with the disclosure can include at least three processing units, e.g., the first processing unit, the second processing unit, and the third processing unit. The first processing unit can obtain the data transmitted to the processor, and determine whether the data is to be processed by the first processing unit, the second processing unit, or the third processing unit. The second processing unit can be configured to process the data using the neural network, and the third processing unit can be configured to perform feature extraction on the data. The processor consistent with the disclosure can further include the system control unit configured to control the power supply information of each of the at least three processing units, and the storage unit configured to store at least the data processing algorithms needed by the first processing unit, the second processing unit, and the third processing unit. In some embodiments, the data can be obtained by the processor and processed by the first processing unit, the second processing unit, or the third processing unit, such that the data can be processed by the processor other than the CPU. The first processing unit, the second processing unit and the third processing unit can be configured to process different data, and thus, different types of data can be processed in the processor at the same time, thereby improving the data processing speed of the processor. The problems of heavy load and high-power consumption caused by all data being processed in the same processor or processing unit can be avoided, the power consumption requirement of the CPU can be reduced, and the operating efficiency of the system can be improved.

The processor shown in FIG. 1 includes at least three processing units. The at least three processing units includes the first processing unit 11, the second processing unit 12, and the third processing unit 13. The processor further includes the system control unit 14 and the storage unit 15.

In some embodiments, the first processing unit 11 of the processor consistent with the disclosure can be further configured to obtain data of an external device via a positive and negative plug interface, such that the processor can process the data of the external device.

The processor can obtain the data detected by each external sensor, and after processing the data, output the processed data to the central processing unit (CPU). The processor and the CPU can form an electronic device, and the processor can further obtain data from other external devices.

In some embodiments, the external device can be connected through the positive and negative plug interface, and the south bridge (PCH) of the CPU can be connected through a channel of the positive and negative plug interface that is used as a normal universal series bus 2.0 (USB2.0) data transmission channel. The data of the external device can be obtained through another channel of the positive and negative plug interface, and the external device can be controlled through this channel.

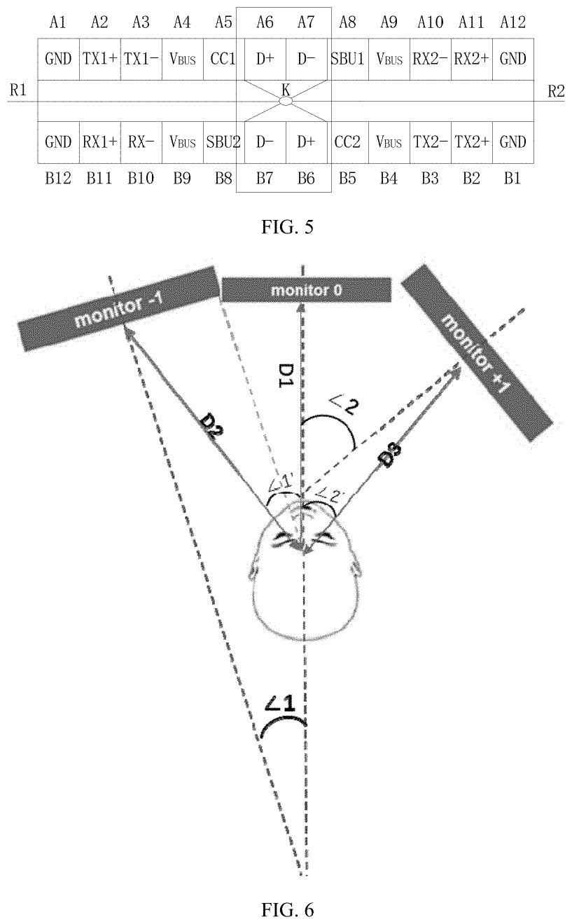

In some embodiments, the positive and negative plug interface can include a Type-C interface having two identical data transmission channels connected to each other. FIG. 5 is a schematic diagram showing realization of multiplexing a connection channel of the positive and negative plug interface consistent with the disclosure. As shown in FIG. 5, the positive and negative plug interface includes contact points A1 to Al2 and B1 to B12, where A1 to A12 can form a first connection channel, and B1 to B12 can form a second connection channel. In the conventional technologies, A6 and B6 as well as A7 and B7 are in a cross-connected state, which causes the first connection channel and the second connection channel in a connected state. However, when a connection is established via the Type-C interface, one of the connection channels can be used for connecting, and the other connection channel is in an idle state.

In this embodiment, an intersection between a first connection line of A6 and B6 and a second connection line of A7 and B7 (e.g., point K in FIG. 5) can be hollowed out. Two connection lines can be arranged at the point K, e.g., R1 and R2, one of which can be connected to the south bridge of the CPU, and another one can be connected to the processor. Therefore, the first connection line and the second connection line are not connected at the cross point. When the external device is connected to the electronic device including the CPU and the processor via the Type-C interface, one of the connection lines can be connected to the south bridge (PCH) for normal data transmission, and another connection line can be connected to the processor, such that the processor can process the data of the external device.

The processor can process data, e.g., a color temperature, a brightness, and a liquid crystal flip angle of a display screen of the external device, or can adjust parameters of a camera, a sensor and other devices in the external device.

For example, the external device can include the display screen, and the processor can be connected to the display screen through one connection line of the Type-C interface. The processor can obtain information such as the brightness, color temperature, and liquid crystal flip angle of the display screen. The processor can obtain image information obtained by the camera on the display screen, such that the first processing unit 11 and the second processing unit 12 of the processor can determine an angle of the display screen relative to the user. As such, the processor can determine whether the angle of the display screen needs to be adjusted, and if necessary, the processor can send an adjustment command to the display screen through the connection line of the Type-C interface, such that the display screen can adjust its angle relative to the user.

FIG. 6 is a schematic diagram showing controlling the external display via the processor consistent with the disclosure. As shown in FIG. 6, three display screens including monitor0, monitor−1, and monitor+1 are arranged in front of the user. Monitor0 is directly connected to a host, and monitor−1 and monitor+1 are connected to the host via the Type-C interface. When monitor−1 and monitor+1 are connected to the host via the Type-C interface, the first connection line in the Type-C interface can be connected to the CPU of the host, and the second connection line can be connected to the processor in the host.

The monitor0 and a user's face can be directly opposite to each other.

A camera on the monitor0 can determine a distance between the user's face and the display screen. For the second connection line, the processor can obtain distances of the monitor−1 and monitor+1 relative to the user's face via the second connection line. For example, a vertical distance between the user's face and the monitor0 is D1, the distance between the user's face and a center point of the left display screen (monitor−1) is D2, and a distance between the user's face and a center point of the right display screen (monitor+1) is D3.

A sensor on the display screen can further determine an angle between a connection line of the center point of the left display screen (monitor−1) and the user's face and a direction when the user is facing the host display screen (monitor0) as ∠1, and an angle between a connection line between the screen point of the right display screen (monitor+1) and the user's face and the direction when the user is facing the host display screen (monitor0) as φ2.

An angle between a vertical line of the center point of the left display screen (monitor−1) and an extension line of the direction when the user is facing the host display screen (monitor0) can be determined as ∠1′, and an angle between a vertical line of the center point of the right display screen (monitor+1) and the extension line of the direction when the user is facing the host display screen (monitor0) can be determined as ∠2′.

The first processing unit 11 and/or the second processing unit 12 of the processor can determine relative positions between the user and the left display screen (monitor−1) or the right display screen (monitor+1), and generate deflection angles. The deflection angles can be transmitted to the left display screen (monitor−1) and the right display screen (monitor+1) via the second connection line, such that the left display screen (monitor−1) and the right display screen (monitor+1) can change the deflection angles with the user's position. The control of the external device using the processor can be realized, and a problem of increasing the amount of data processed by the CPU caused by controlling the external device through the CPU can be avoided.

In some other embodiments, a resolution of an imaged displayed by an external monitor can be controlled via the second connection line. For example, a super-division control circuit can be arranged at the external monitor. When the resolution of the image transmitted by the second connection line is low, the processor can send an over-division control command to the external display through the second connection line. Therefore, the external monitor can improve the resolution of the image displayed by the external monitor through the internal super-division control circuit.

The processor consistent with the disclosure can include at least three processing units, e.g., the first processing unit 11, the second processing unit 12, and the third processing unit 13. The first processing unit 11 can obtain the data transmitted to the processor, and determine whether the data is to be processed by the first processing unit 11, the second processing unit 12, or the third processing unit 13. The second processing unit 12 can be configured to process the data using the neural network, and the third processing unit 13 can be configured to perform feature extraction on the data. The processor consistent with the disclosure can further include the system control unit 14 configured to control the power supply information of each of the at least three processing units, and the storage unit 15 configured to store at least the data processing algorithms needed by the first processing unit 11, the second processing unit 12, and the third processing unit 13. In some embodiments, the data can be obtained and processed by the first processing unit 11, the second processing unit 12, or the third processing unit 13, such that the data can be processed by the processor other than the CPU. The first processing unit 11, the second processing unit 12 and the third processing unit 13 can be configured to process different data, and thus, different types of data can be processed in the processor at the same time, thereby improving a data processing speed of the processor. The problems of heavy load and high-power consumption caused by all data being processed in the same processor or processing unit can be avoided, the power consumption requirements of the CPU can be reduced, and the operating efficiency of the system can be improved.

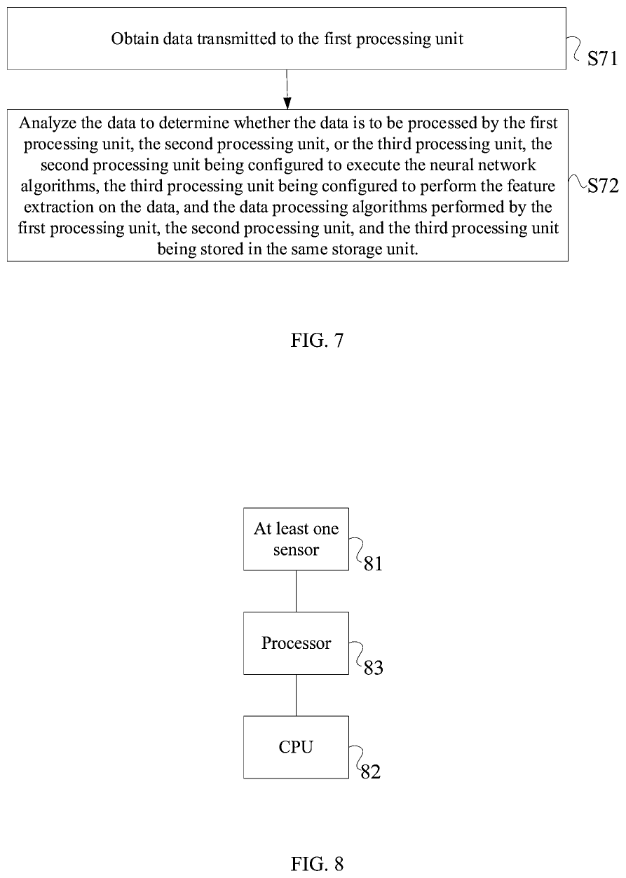

FIG. 7 is a flowchart of a data processing method consistent with the disclosure. As shown in FIG. 7 the data processing method includes the following processes.

At S71, the data transmitted to the first processing unit is obtained.

At S72, the data is analyzed to determine whether the data is to be processed by the first processing unit, the second processing unit, or the third processing unit, the second processing unit configured to execute the neural network algorithms, the third processing unit configured to perform the feature extraction on the data, and the data processing algorithms performed by the first processing unit, the second processing unit, and the third processing unit stored in the same storage unit.

The storage unit can further be configured to store the data detected by the at least one sensor.

Obtaining the data transmitted to the first processing unit can include obtaining the data detected by the at least one sensor stored in the storage unit.

The storage unit can be further configured to store the processing results obtained by the first processing unit, the second processing unit, and the third processing unit after processing the data.

The first processing unit can store the processing results obtained by the first processing unit, the second processing unit, or the third processing unit in the storage unit, and send a notification message notifying that the processing results are stored in the storage unit to the CPU. The storage unit can be further configured to send the stored processing results to the CPU according to the call command of the CPU.

The processor can further include the switch module including at least two states.

When the switch module is in the first state, the first processing unit can obtain the audio data, such that the processor can perform the ultrasonic detection on the part of the audio data.

When the switch module is in the second state, the first processing unit does not obtain the audio data.

In some embodiments, the first processing unit can further obtain the data of the external device through the positive and negative plug interface, such that the processor can process the data of the external device.

In some embodiments, the first processing unit obtaining the data of the external device through the positive and negative plug interface can include the following processes. The first processing unit can be connected to the positive and negative plug interface, such that the positive and negative plug interface can have two transmission channels. The first processing unit can obtain first data of the external device through a first transmission channel of the positive and negative plug interface. The central processing unit (CPU) can obtain second data of the external device through a second transmission channel of the positive and negative plug interface.

In some embodiments, the first processing unit can be further configured to output a control command according to the first data of the external device, and the control command can be sent to the external device through the first transmission channel of the positive and negative plug interface, such that the external device can be adjusted according to the control command.

The data processing method consistent with the disclosure can be implemented by the processor consistent with the disclosure, and detailed description will be omitted herein.

The data processing method consistent with the disclosure can obtain the data transmitted to the first processing unit, and analyze the data to determine whether the data is to be processed by the first processing unit, the second processing unit or the third processing unit. The second processing unit can be configured to execute the neural network algorithms, the third processing unit can be configured to perform the feature extraction on the data, and the data processing algorithms performed by the first processing unit, the second processing unit, and the third processing unit can be stored in the same storage unit. In this embodiment, the data can be obtained and processed by the first processing unit, the second processing unit, or the third processing unit, thereby realizing processing the data by the processor other than the CPU. The first processing unit, the second processing unit and the third processing unit can be configured to process different data, thereby realizing that different types of data can be processed in the processor at the same time, which improves the data processing speed of the processor. The problems of heavy load and high power consumption caused by all data being processed in the same processor or processing unit can be avoided, the power consumption requirements of the CPU can be reduced, and the operating efficiency of the system can be improved.

FIG. 8 is a schematic structural diagram of an electronic device consistent with the disclosure. As shown in FIG. 8, the electronic device includes at least one sensor 81, a central processing unit (CPU) 82 and a processor 83.

The at least one sensor can be configured to detect data and send the data to the processor.

The CPU can be configured to obtain the processing results output by the processor.

The processor can include the system control unit, the storage unit, and at least three processing units. The at least three processing units includes the first processing unit, the second processing unit, and the third processing unit.

The first processing unit can obtain data transmitted to the processor, and determine whether the data is to be processed by the first processing unit, the second processing unit, or the third processing unit.

The second processing unit can be configured to execute the neural network algorithms.

The third processing unit can be configured to perform the feature extraction algorithm on the data.

The system control unit can be configured to control the power supply information of each of the at least three processing units.

The storage unit can be configured to store at least the data processing algorithms performed by the first processing unit, the second processing unit, and the third processing unit.

The electronic device consistent with the disclosure are based on the processors described above, and detailed description will be omitted herein.

The processor consistent with the disclosure can include at least three processing units, e.g., the first processing unit, the second processing unit, and the third processing unit. The first processing unit can obtain the data transmitted to the processor, and determine whether the data is to be processed by the first processing unit, the second processing unit, or the third processing unit. The second processing unit can be configured to process the data using the neural network, and the third processing unit can be configured to perform feature extraction on the data. The processor consistent with the disclosure can further include the system control unit configured to control the power supply information of each of the at least three processing units, and the storage unit configured to store at least the data processing algorithms needed by the first processing unit, the second processing unit, and the third processing unit. In some embodiments, the data can be obtained by the processor and processed by the first processing unit, the second processing unit, or the third processing unit, such that the data can be processed by the processor other than the CPU. The first processing unit, the second processing unit and the third processing unit can be configured to process different data, and thus, different types of data can be processed in the processor at the same time, thereby improving the data processing speed of the processor. The problems of heavy load and high-power consumption caused by all data being processed in the same processor or processing unit can be avoided, the power consumption requirement of the CPU can be reduced, and the operating efficiency of the system can be improved.

In the present specification, the embodiments are described in a gradual and progressive manner with the emphasis of each embodiment on an aspect different from other embodiments. The same or similar parts among the various embodiments may refer to each other. Since the disclosed apparatus according to the embodiment corresponds to the disclosed method according to the embodiment, detailed description of the disclosed apparatus is omitted, and reference can be made to the description of the methods for a description of the relevant parts of the apparatus.

Those skilled in the art may further understood that the example units and algorithm processes described in the disclosed embodiments can be implemented by an electronic hardware, a computer software, or a combination of thereof. In order to clearly illustrate an interchangeability of hardware and software, the composition and processes of each example have been generally described in accordance with the functions in the specification. Whether these functions are executed by hardware or software depends on the specific application and design constraint conditions of the technical solution. Those skilled in the art can use different methods for each specific application to implement the described functions, but such implementation should not be considered beyond the scope of this application.

The processes of the method or algorithm described in the disclosed embodiments can be directly implemented by hardware, a software module executed by a processor, or a combination of thereof. The software module can be stored in a random-access memory (RAM), an internal memory, a read-only memory (ROM), an electrically programmable ROM, an electrically erasable programmable ROM, a register, a hard disk, a removable disk, a CD-ROM, or any other form of storage medium known in the technical field.

The foregoing description of the disclosed embodiments will enable a person skilled in the art to realize or use the present disclosure. Various modifications to the embodiments will be apparent to those skilled in the art. The general principles defined herein may be implemented in other embodiments without departing from the spirit or scope of the disclosure. Accordingly, the disclosure will not be limited to the embodiments shown herein, but is to meet the broadest scope consistent with the principles and novel features disclosed herein.

What is claimed is:

1. A processor comprising:
a first processing unit, a second processing unit, and a third processing unit, wherein:
the first processing unit is configured to obtain data transmitted to the processor and determine whether the data is to be processed by the first processing unit, the second processing unit, or the third processing unit;
the second processing unit is configured to execute a neural network algorithm; and
the third processing unit is configured to perform a feature extraction algorithm on the data;
a system control unit configured to control power supply information of each of the first processing unit, the second processing unit, and the third processing unit; and
a storage unit configured to store at least data processing algorithms performed by the first processing unit, the second processing unit, and the third processing unit.

2. The processor according to claim 1, wherein:
the storage unit is further configured to store data detected by at least one sensor; and
the data transmitted to the processor includes the data detected by the at least one sensor and stored in the storage unit.

3. The processor according to claim 1, wherein:
the storage unit is further configured to store a processing result obtained by the first processing unit, the second processing unit, or the third processing unit after processing the data.

4. The processor according to claim 3, wherein:
the first processing unit is further configured to store the processing result to the storage unit, and send a notification message that the processing result is stored in the storage unit to a central processing unit (CPU); and
the storage unit is further configured to send the stored processing result to the CPU according to a call command of the CPU.

5. The processor according to claim 1, further comprising:
a switch having at least two states, wherein:
in response to the switch being in a first state, the first processing unit obtains audio data, such that the processor performs an ultrasonic detection on a part of the audio data; and
in response to the switch being in a second state, the first processing unit does not obtain the audio data.

6. The processor according to claim 1, wherein:
the data includes data of an external device obtained via a positive and negative plug interface.

7. The processor according to claim 6, wherein the first processing unit is connected to the positive and negative plug interface, such that the positive and negative plug interface has:
a first transmission channel through which the first processing unit obtains first data of the external device; and
a second transmission channel through which a central processing unit (CPU) obtains second data of the external device.

8. The processor according to claim 7, wherein:
the first processing unit is further configured to output a control command according to the first data of the external device; and
the control command is sent to the external device through the first transmission channel, to cause the external device to adjust according to the control command.

9. A data processing method comprising:
obtaining data transmitted to a first processing unit; and
analyzing the data to determine whether the data is to be processed by the first processing unit, a second processing unit, or a third processing unit;
wherein:
the second processing unit is configured to execute a neural network algorithm;
the third processing unit is configured to perform feature extraction on the data; and
data processing algorithms performed by the first processing unit, the second processing unit, and the third processing unit are stored in a same storage unit.

10. The method according to claim 9, wherein:
obtaining the data transmitted to the processor includes obtaining data detected by at least one sensor and stored in the storage unit.

11. The method according to claim 9, further comprising:
storing a processing result obtained by the first processing unit, the second processing unit, or the third processing unit after processing the data to the storage unit.

12. The method according to claim 11, further comprising:
sending a notification message that the processing result is stored in the storage unit to a central processing unit (CPU); and
controlling the storage unit to send the stored processing result to the CPU according to a call command of the CPU.

13. The method according to claim 9, further comprising:
in response to a switch coupled to the first processing unit being in a first state, obtaining audio data for performing an ultrasonic detection on a part of the audio data; and
in response to the switch being in a second state, not obtaining the audio data.

14. The method according to claim 9, wherein:
obtaining the data includes obtaining data of an external device via a positive and negative plug interface.

15. The method according to claim 14, wherein the first processing unit is connected to the positive and negative plug interface, such that the positive and negative plug interface has:
a first transmission channel through which the first processing unit obtains first data of the external device; and
a second transmission channel through which a central processing unit (CPU) obtains second data of the external device.

16. The method according to claim 15, further comprising:
outputting a control command according to the first data of the external device to the external device through the first transmission channel, to cause the external device to adjust according to the control command.

17. An electronic device comprising:
a sensor configured to detect data;
a processor including:
a first processing unit, a second processing unit, and a third processing unit, wherein:
the first processing unit is configured to obtain the data and determine whether the data is to be processed by the first processing unit, the second processing unit, or the third processing unit;
the second processing unit is configured to execute a neural network algorithm; and
the third processing unit is configured to perform a feature extraction algorithm on the data;
a system control unit configured to control power supply information of each of the first processing unit, the second processing unit, and the third processing unit; and
a storage unit configured to store at least data processing algorithms performed by the first processing unit, the second processing unit, and the third processing unit; and
a central processing unit (CPU) configured to obtain a processing result output by the processor.

18. The electronic device according to claim 17, wherein:
the storage unit is further configured to store data detected by at least one sensor; and
the data transmitted to the processor includes the data detected by the at least one sensor and stored in the storage unit.

19. The electronic device according to claim 17, wherein:
the storage unit is further configured to store the processing result obtained by the first processing unit, the second processing unit, or the third processing unit after processing the data.

20. The electronic device according to claim 19, wherein:
the first processing unit is further configured to store the processing result to the storage unit, and send a notification message that the processing result is stored in the storage unit to the CPU; and
the storage unit is further configured to send the stored processing result to the CPU according to a call command of the CPU.
